(19) United States
(12) Patent Application Publication
(10) Pub. No.: US 2026/0175760 A1
(43) Pub. Date: Jun. 25, 2026

(54) TEMPERATURE-CONTROLLED CUP

(71) Applicant: Shenzhen Lute Jiacheng Supply Chain Management Co., Ltd., Shenzhen (CN)

(72) Inventors: Hong XIE, Shenzhen (CN); Kexin FU, Shenzhen (CN)

(73) Assignee: Shenzhen Lute Jiacheng Supply Chain Management Co., Ltd., Shenzhen (CN)

(21) Appl. No.: 19/538,789

(22) Filed: Feb. 12, 2026

Related U.S. Application Data
(63) Continuation-in-part of application No. PCT/CN2025/071577, filed on Jan. 9, 2025.

(30) Foreign Application Priority Data
Jan. 25, 2024 (CN) 202420179356.5
Sep. 25, 2024 (CN) 202422348090.5

(51) Int. Cl. B60N 3/10; A47J 36/24; B65D 81/18; B65D 81/32; B65D 81/38

(52) U.S. Cl. CPC B60N 3/104; A47J 36/2466; B65D 81/18; B65D 81/3211; B65D 81/3823; B65D 81/3876

(57) ABSTRACT

A temperature-controlled cup is provided, including an outer container, comprising a total accommodating chamber; a cover portion, in threaded connection with the outer container; and at least one medium holder, removably accommodated in the total accommodating chamber, each of the at least one medium holder includes a heat-insulation chamber for accommodating a target object, and a storage space for accommodating a temperature-regulating medium.

### RELATED APPLICATIONS

This application is a continuation-in-part (CIP) application of PCT application No. PCT/CN2025/071577, filed on Jan. 9, 2025; the PCT application claims the benefit of priority to Chinese Patent Application No. 202420179356.5, filed on Jan. 25, 2024, and to Chinese Patent Application No. 202422348090.5, filed on Sep. 25, 2024; the entire contents of the foregoing documents are incorporated herein by reference.

### TECHNICAL FIELD

The present disclosure relates to the field of baby care equipment, specifically to a temperature-controlled cup.

### BACKGROUND

Beverages such as breast milk, cow's milk, and water typically require refrigeration to prevent spoilage, and some beverages may taste better when frozen. Traditionally, beverages are placed directly in a refrigerator for cooling; for example, breast milk is extracted using a breast pump and then placed in the refrigerator for storage. However, refrigerators are usually large, stationary appliances that require a power connection and must be positioned in a fixed location. This lack of portability means they cannot be used for on-the-go cooling or heating.

In light of these issues, various temperature-controlled cups have appeared on the market. Conventional temperature-controlled cups achieve heating and cooling functions by directly placing ice cubes or hot water in the gap between the inner and outer containers. However, this method suffers from low heat transfer efficiency and uneven temperature distribution, as ice cubes tend to settle at the bottom of the outer container, concentrating the temperature exchange at the base of the cup.

### SUMMARY

In view of the deficiencies of the existing technology, embodiments of the present disclosure provide a temperature-controlled cup that addresses the issue of deformation in the medium holders.

To solve the aforementioned technical problem, in a first aspect, the present disclosure provides a temperature-controlled cup, including: an outer container including a total accommodating chamber; a cover portion, in threaded connection with the outer container; and at least one medium holder, removably accommodated in the total accommodating chamber, where each of the at least one medium holder includes: a heat-insulation chamber for accommodating a target object, and a storage space for accommodating a temperature-regulating medium.

In a second aspect, the present disclosure provides a temperature-controlled cup, including: an outer container; a cover portion, threadedly connected with the outer container; and at least one inner container, removably accommodated in the outer container, where a storage space is formed between the at least one inner container and the outer container to accommodate a temperature-regulating medium.

The present disclosure can enhance the efficiency of heat transfer between the temperature-regulating medium and the inner container and improves the uniformity of temperature distribution, while also minimizing deformation of the medium holders, thereby extending their service life.

### BRIEF DESCRIPTION OF THE DRAWINGS

In order to more clearly describe the technical solutions of the embodiments in the present disclosure, a brief introduction of the drawings used in the description of the embodiments will be provided below. It should be understood that the drawings described below are merely illustrative of certain embodiments of the present disclosure. For a person skilled in the art, additional drawings can be derived from the structures shown in these drawings without requiring inventive efforts.

FIG. 1 is a structural schematic diagram of the temperature-controlled cup according to some exemplary embodiments of the present disclosure;

FIG. 2 is an exploded view of the temperature-controlled cup according to some exemplary embodiments of the present disclosure;

FIG. 3 is a cross-sectional view of the temperature-controlled cup according to some exemplary embodiments of the present disclosure;

FIG. 4 is a structural schematic diagram of the medium holder according to some exemplary embodiments of the present disclosure;

FIG. 5 is an exploded view of the medium holder according to some exemplary embodiments of the present disclosure;

FIG. 6 is an exploded view of the temperature-controlled cup according to some exemplary embodiments of the present disclosure;

FIG. 7 is a cross-sectional view of the temperature-controlled cup according to some exemplary embodiments of the present disclosure;

FIG. 8 is a first perspective view of the medium holder according to some exemplary embodiments of the present disclosure;

FIG. 9 is a second perspective view of the medium holder according to some exemplary embodiments of the present disclosure;

FIG. 10 is an exploded view of the medium holder according to some exemplary embodiments of the present disclosure;

FIG. 11 is a schematic sectional view showing the medium holder according to some exemplary embodiments of the present disclosure;

FIG. 12 is a schematic structural diagram of the temperature-controlled cup according to some exemplary embodiments of the present disclosure;

FIG. 13 is an exploded structural diagram of the temperature-controlled cup according to some exemplary embodiments of the present disclosure;

FIG. 14 is a schematic cross-sectional view of the temperature-controlled cup according to some exemplary embodiments of the present disclosure; and

FIG. 15 is a schematic sectional view of the medium holder according to some exemplary embodiments of the present disclosure.

The objectives, features, and advantages of the present disclosure will be further described in conjunction with some exemplary embodiments with referring to the accompanying drawings.

### DETAILED DESCRIPTION

In the present disclosure, the terms “provided,” “disposed,” and “connected” should be broadly understood. For example, they can refer to fixed connections, detachable connections, or integrated structures. They may indicate mechanical connections or electrical connections, direct connections, or indirect connections through an intermediary, or they may refer to internal communication between two devices, components, or parts. A person skilled in the art can understand the specific meaning of these terms in the present disclosure according to the context.

The terms “center,” “longitudinal,” “transverse,” “length,” “width,” “thickness,” “top,” “bottom,” “front,” “back,” “left,” “right,” “vertical,” “horizontal,” “top,” “bottom,” “inner,” “outer,” “radial,” and “circumferential” indicate directional or positional relationships based on the orientation or positional relationships shown in the figures. These terms are used solely to simplify and clarify the description of the present disclosure and should not be interpreted as limiting the disclosure to a specific orientation, construction, or operation.

In the present disclosure, the expression “X comprises at least one of A, B, or C” means that X comprises at least A, or X comprises at least B, or X comprises at least C. That is, X may comprise only any one of A, B, or C, or may comprise any combination of A, B, and C, as well as other possible contents/elements. Any combination of A, B, and C may be A, B, C, AB, AC, BC, or ABC.

Additionally, the terms “first” and “second” are used only for descriptive purposes and should not be understood as indicating relative importance or implying the number of features. Therefore, a “first” or “second” feature may explicitly or implicitly include one or more of that feature. In the description of the present disclosure, “multiple” means at least two, such as two or three, unless otherwise explicitly specified.

Moreover, the above terms, in addition to indicating directional or positional relationships, may also have other meanings. For example, the term “top” may also refer to attachment or connection relationships. A person skilled in the art can understand these terms according to the specific context.

The terms “a” and “an” are defined as one or more unless this disclosure explicitly requires otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

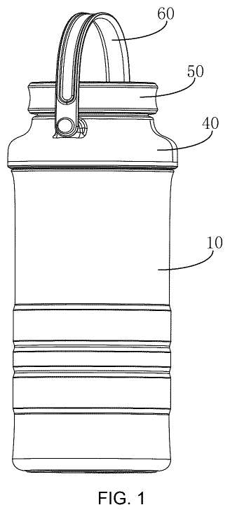

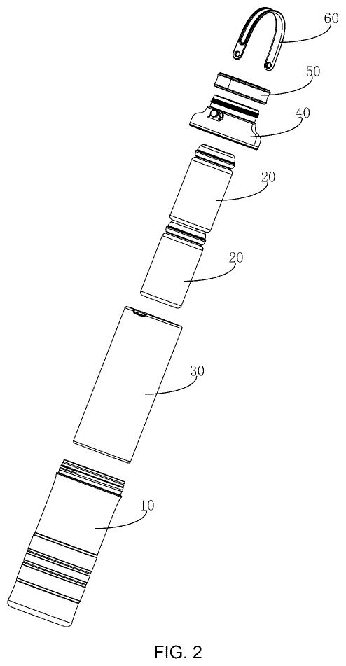

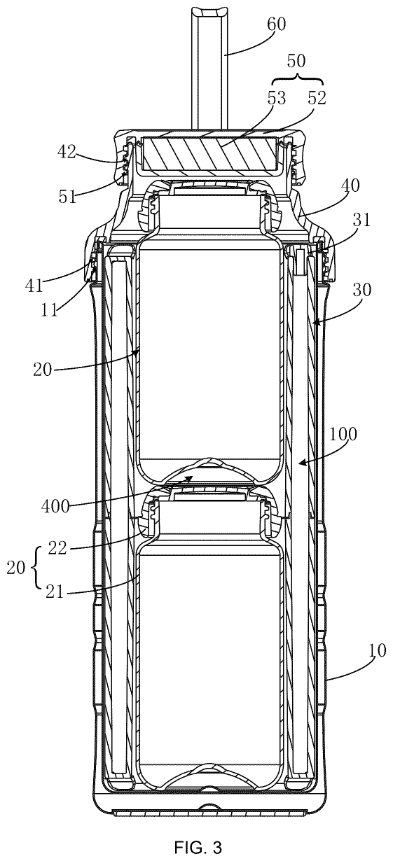

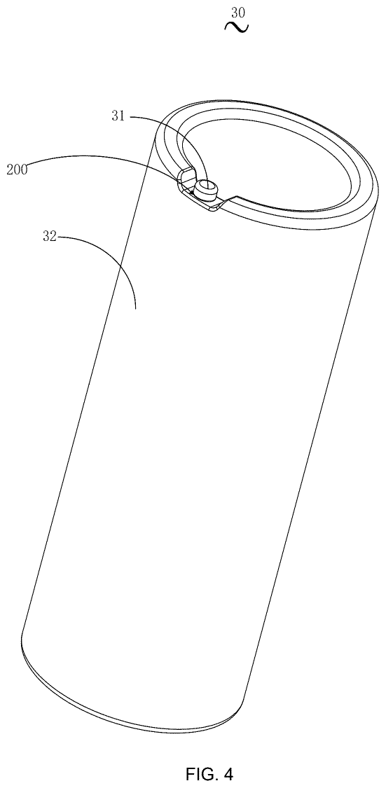

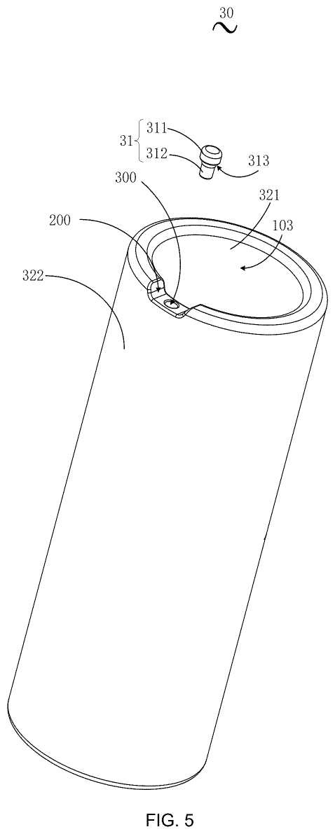

Please refer to FIG. 1, FIG. 2, FIG. 3, FIG. 4, and FIG. 5. FIG. 1 illustrates a structural schematic diagram of the temperature-controlled cup according to some exemplary embodiments of the present disclosure; FIG. 2 shows an exploded view of the temperature-controlled cup according to some exemplary embodiments; FIG. 3 presents a cross-sectional view of the temperature-controlled cup according to some exemplary embodiments; FIG. 4 provides a structural schematic diagram of the medium holder according to some exemplary embodiments; and FIG. 5 depicts an exploded view of the medium holder according to some exemplary embodiments.

In some exemplary embodiments, the temperature-controlled cup includes: an outer container 10, an inner container 20, a medium holder 30, and temperature-regulating medium (not shown in the figures).

The inner container 20 is designed to be removably accommodated within the outer container 10. The medium holder 30 is also removably accommodated within the outer container 10 and is positioned between the outer container 10 and the inner container 20. The medium holder 30 is provided with a storage space 100, the temperature-regulating medium is accommodated within the storage space 100.

Some exemplary embodiments of the present disclosure provide a temperature-controlled cup that includes the outer container 10, inner container 20, medium holder 30, and temperature-regulating medium. The inner container 20 can be removed from the outer container 10, and the medium holder 30 is positioned in such a way that it is removably situated between the outer container 10 and the inner container 20. The medium holder 30 has a defined storage space 100, in which the temperature-regulating medium is accommodated. This configuration enhances the efficiency of heat transfer and improves the uniformity of temperature distribution.

Testing has been conducted by placing ice between the inner and outer containers as a comparative example. Both the ice and the medium holder were pre-cooled in a refrigerator before being inserted into the gap between the inner and outer containers. The results showed that the cooling efficiency of the medium holder configuration was significantly higher during the initial cooling phase compared to the method of using ice alone, and the uniformity of cooling across different areas was also noticeably superior to that of the comparative example.

It should be understood that the temperature-controlled cup of the present disclosure is not limited to cooling the liquid in the inner container 20; it can also be used to heat the liquid in the inner container 20. For example, the medium holder 30 can be pre-cooled by placing it in the refrigerator for a period of time and then placed inside the outer container 10, thereby allowing the liquid in the inner container 20 to be cooled. In another usage scenario, the medium holder 30 can be pre-heated by immersing it in boiling water for a period of time before being placed inside the outer container 10, thus heating the liquid in the inner container 20.

In some usage scenarios, two medium holders 30 can be used interchangeably, with the temperature-regulating media accommodated within the two medium holders being different; one can be used for heat storage, while the other can be used for cold storage. Of course, it is also possible to use only one medium holder 30 that is capable of both heat storage and cold storage. The temperature-regulating medium is typically selected from liquids or solids with a high specific heat capacity, or gels. For example, in some exemplary embodiments, the temperature-regulating medium can be a cold gel, or it may consist of an aqueous solution of ethylene glycol or propylene glycol, or it may simply be water. The present disclosure does not limit the selection of the temperature-regulating medium.

In some exemplary embodiments, the medium holder 30 is cylindrical and surrounds the inner container 20 when the inner container 20 is accommodated within the outer container 10. In some exemplary embodiments, the medium holder may include a bottom wall, which can further improve the efficiency of heat transfer.

In some exemplary embodiments, the medium holder 30 includes a sealing member 31 and a cylindrical body 32, with the body 32 having a notch 200 formed at its end, the notch 200 being provided with an injection port 300, and the sealing member 31 being placed at the injection port 300 and configured to seal the injection port 300.

In some exemplary embodiments, the temperature-controlled cup further includes a connector 40, where the connector 40 has a first coupling structure 41, and the outer container 10 has a second coupling structure 11 corresponding to the first coupling structure 41. The first coupling structure 41 may be a threaded structure located on the connector 40, while the second coupling structure 11 may be a threaded structure on the outer container 10 that matches the threaded structure on the connector 40. For example, one of the first coupling structure 41 or the second coupling structure 11 can be an internal thread, while the other can be an external thread. In some exemplary embodiments, the first coupling structure 41 and the second coupling structure 11 may employ alternative coupling methods, such as snap-fit or interference fit; the present disclosure does not limit the methods of coupling.

In some exemplary embodiments, the first coupling structure 41 is located on the inner wall of the connector 40, while the second coupling structure 11 is located on the outer wall of the outer container 10. By positioning the second coupling structure 11 on the outer wall of the outer container 10, this arrangement does not interfere with the removal and insertion of the inner container 20 and the medium holder 30 from the outer container 10. For example, the first coupling structure 41 can be an internal threaded structure on the inner wall of the connector 40, and the second coupling structure 11 can be an external threaded structure on the outer wall of the outer container 10. The connector 40 and the outer container 10 are coupled together via this threaded connection.

In some exemplary embodiments, the temperature-controlled cup may also include a lid 50, where a first end of the connector 40 is configured to connect the outer container 10, and a second end of the connector 40 is configured to connect the lid 50. The diameter of the first end of the connector 40 is larger than the diameter of the second end of the connector 40. This design allows for a larger diameter of the outer container 10, facilitating the insertion of the inner container 20 and the medium holder 30 into the outer container 10. To make it easier to detach the connector 40 from the outer container 10, the diameter of the end of the connector 40 that connects to the lid 50 is set to be smaller than the diameter of the end that connects to the outer container 10. This enables a user to grip the connector 40 for rotation while ensuring that the outer container 10 has a sufficiently large diameter to allow for the removal and insertion of the inner container 20 and the medium holder 30.

In some exemplary embodiments, the lid 50 is provided with a third coupling structure 51, and the connector 40 has a fourth coupling structure 42. The lid 50 and the connector 40 are connected and can be detached from each other via the engagement of the third coupling structure 51 and the fourth coupling structure 42. The third coupling structure 51 and the fourth coupling structure 42 can be corresponding threaded structures. For example, the third coupling structure 51 can be an internal threaded structure located on the inner wall of the lid 50, while the fourth coupling structure 42 can be an external threaded structure located on the outer wall of the connector 40. By ensuring that the diameter of the end of the connector 40 that connects to the lid 50 is smaller than that of the end that connects to the outer container 10, this allows a user to comfortably grip the lid 50 for rotation while also ensuring that the outer container 10 has a sufficiently large diameter to accommodate the removal and insertion of the inner container 20 and the medium holder 30.

In some exemplary embodiments, the temperature-controlled cup may also include a handle 60, which is connected to the connector 40. This handle 60 can be used by the user to lift the temperature-controlled cup. Additionally, the handle 60 facilitates the user in gripping the handle 60 to twist the connector 40, thereby making it easier to tighten or loosen the threaded connection between the connector 40 and the outer container 10.

In some exemplary embodiments, the number of inner containers 20 is at least two, with the at least two inner containers 20 being stacked within the outer container 10. By providing at least two inner containers 20, it is possible to store breast milk collected at different times separately. For instance, breast milk extracted by a breast pump at different times can be stored in separate containers, thereby avoiding mixing of milk collected at different times. This separation is important as milk stored for extended periods may affect the quality of freshly collected milk, potentially leading to cross-contamination and spoilage. In some exemplary embodiments, the number of inner containers 20 is two, although in some exemplary embodiments, the number of inner containers 20 can also be one or three or more, and the present disclosure does not impose a limitation on that.

In some exemplary embodiments, the bottom of each inner container 20 is designed with a recessed structure 400. By incorporating this recessed structure 400, when at least two inner containers 20 are stacked within the outer container 10, the top of the lower inner container 20 can at least partially nest within the recessed structure 400 of the upper inner container 20. This design not only saves space but also ensures the stability of the stacked inner containers 20.

In some exemplary embodiments, the inner container 20 is provided with a connector structure that is compatible with a breast pump or a nipple. For example, the inner container 20 may include a bottle body 21 and a bottle cap 22, which are connected via threads. The threads on the bottle body 21 may match with the outlet thread of the triport structure (negative pressure interface, suction channel, and outlet) of the breast pump, allowing the milk extracted by the breast pump to be directly collected into the inner container 20. Alternatively, the threads on the bottle body 21 may be configured to connect with a lid that has a nipple, enabling the inner container 20 to be directly used for feeding infants after the connection is made.

In some exemplary embodiments, the inner wall of the side wall and/or bottom wall of the outer container 10 is designed with a vacuum insulation chamber. This vacuum insulation chamber maintains a vacuum to effectively isolate the temperature transfer between the temperature-controlled cup and the external environment.

In some exemplary embodiments, the lid 50 consists of a lid shell 52 and insulation material 53 filled inside the lid shell 52. This design reduces the temperature exchange between the interior of the outer container 10 and the external environment. The lid 50, when connected to the connector 40, rests against the upper surface of the inner container 20.

Some exemplary embodiments of the present disclosure provide a temperature-controlled cup that comprises an outer container, an inner container, a medium holder, and a temperature-regulating medium. The inner container is removably accommodated within the outer container, and the medium holder is also removable and positioned between the outer container and the inner container. The medium holder contains a storage space in which the temperature-regulating medium is housed, thereby enhancing the efficiency of heat transfer and improving the uniformity of temperature distribution.

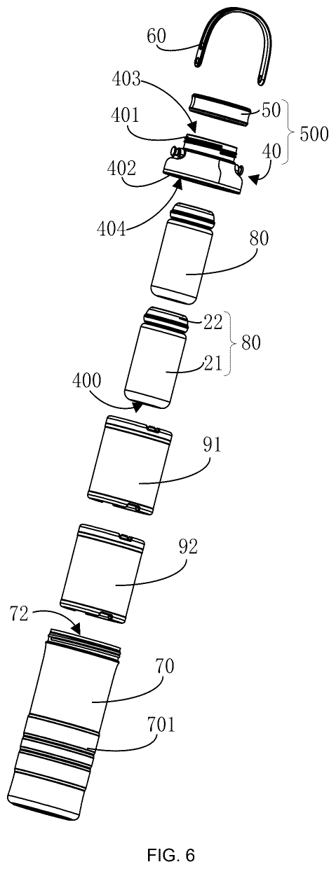

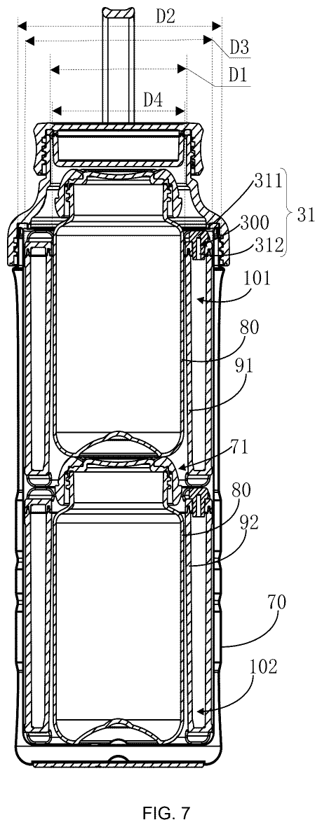

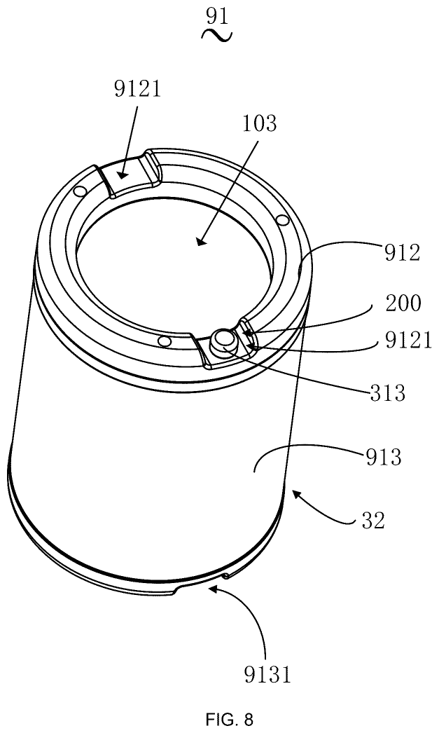

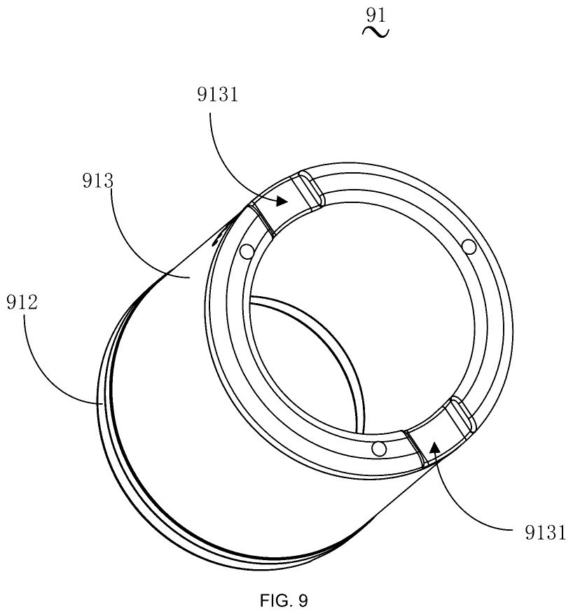

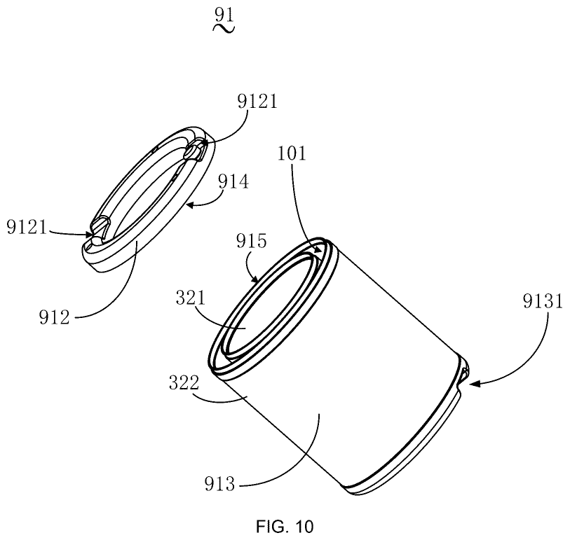

Please refer to FIG. 6, FIG. 7, and FIG. 8. FIG. 6 is an exploded view of the temperature-controlled cup according to some exemplary embodiments of the present disclosure; FIG. 7 is a cross-sectional view of the temperature-controlled cup according to some exemplary embodiments; and FIG. 8 is a first perspective view of the medium holder according to some exemplary embodiments. FIG. 9 is a second perspective view of the medium holder according to some exemplary embodiments; and FIG. 10 is an exploded view of the medium holder according to some exemplary embodiments.

In some exemplary embodiments, the temperature-controlled cup includes an outer container 70, an inner container 80, at least two medium holders 91 and 92, and a temperature-regulating medium (not shown in the figures).

The inner container 80 is removably accommodated within the outer container 70. The at least two medium holders 91 and 92 are also removably accommodated within the outer container 70. Both medium holders 91 and 92 are positioned between the outer container 70 and the inner container 80. Each medium holder 91 and 92 contains a storage space. For example, medium holder 91 has a storage space 101, while medium holder 92 has a storage space 102.

The at least two medium holders 91 and 92 are stacked up and down. In some exemplary embodiments, the number of inner containers 80 can be two, with the two inner containers 80 stacked on top of each other. In some exemplary embodiments, one medium holder 91 may surround one inner container 80. It should be understood that in some exemplary embodiments of the present disclosure, there are two medium holders 91 and 92, but in some exemplary embodiments, three or more medium holders can be used; the present disclosure does not impose a limitation in this regard. The number of inner containers 80 can be one, three, or more, and the present disclosure does not impose a limitation in this regard.

The temperature-regulating medium is accommodated within storage spaces 101 and 102, with each storage space 101 and 102 containing the temperature-regulating medium. Therefore, the storage spaces 101 and 102 can also be referred to as medium spaces.

In some exemplary embodiments, the medium holder 91 has rotational positioning structures 9121 and 9131, which are used to connect a piece of rotating equipment (not shown) to the medium holder 91 or a portion thereof and to drive the medium holder 91 to rotate. In some exemplary embodiments, the medium holder 91 is equipped with rotational positioning structures 9121 and 9131 located on opposite end surfaces. In some exemplary embodiments, two rotational positioning structures 9121 can be located on the same end of the medium holder 91, with the two rotational positioning structures being symmetrically arranged.

In some exemplary embodiments, the medium holder 91 comprises a first part 912 and a second part 913, with the first part 912 and the second part 913 joined together to form the storage space 101.

In some exemplary embodiments, the first part 912 of the medium holder 91 is equipped with a first rotational positioning structure 9121, while the second part 913 is equipped with a second rotational positioning structure 9131.

In some exemplary embodiments, the first rotational positioning structure 9121 is a groove located on the end surface of the first part 912, while the second rotational positioning structure 9131 is a groove located on the end surface of the second part 913.

Some exemplary embodiments of the present disclosure provide a temperature-controlled cup that includes: an outer container; an inner container that is removably accommodated within the outer container; at least two medium holders that are removably accommodated within the outer container and positioned between the outer container and the inner container, with each medium holder having a storage space; the at least two medium holders being stacked vertically; and a temperature-regulating medium housed within the storage spaces. Each storage space contains the temperature-regulating medium, which enhances the efficiency of heat transfer between the temperature-regulating medium and the inner container and improves the uniformity of temperature distribution. Furthermore, the medium holders are not prone to deformation, thereby extending their service life.

Please refer to FIG. 6, FIG. 7, and FIG. 8. A temperature-controlled cup is provided, which includes: an outer container 70, an inner container 80, a medium holder 91, and a temperature-regulating medium (not shown in the figures).

The inner container 80 is designed to be removably accommodated within the outer container 70. The medium holder 91 is also removably accommodated within the outer container 70 and is positioned between the outer container 70 and the inner container 80. The medium holder 91 contains a storage space 101, and the end surface of the medium holder 91 is equipped with a rotational positioning structure 9121. The temperature-regulating medium is housed within the storage space 101.

In some exemplary embodiments, the rotational positioning structure 9121 is a groove 9121 formed on the end surface of the medium holder 91.

With reference to FIGS. 6 and 7, the present disclosure provides a temperature-controlled cup. The temperature-controlled cup includes an outer container 70, a cover portion 500, and at least one medium holder 91. The outer container 70 has a total accommodating chamber 71. The cover portion 500 is in threaded connection with the outer container 70. The at least one medium holder 91 is removably accommodated in the total accommodating chamber 71. Each of the at least one medium holder 91 has a heat-insulation chamber 103 for accommodating a target object, and each of the at least one medium holder 91 further has a storage space 101 for accommodating a temperature-regulating medium.

The temperature-regulating medium serves as a cold source or a heat source. The medium holder 91 can improve the heat transfer efficiency between the temperature-regulating medium of the temperature-controlled cup and the target object, as well as enhance the uniformity of heat transfer.

The cover portion 500 serves to seal the total accommodating chamber 71. After the cover portion 500 is detached from the outer container 70, the user can take the medium holder 91 out of the total accommodating chamber 71. In this way, the temperature-regulating medium can be easily heated or frozen, which facilitates the user in adjusting the temperature of the temperature-regulating medium.

In some exemplary embodiments, the temperature-controlled cup can be a milk freezing pot for storing breast milk.

In some exemplary embodiments, with reference to FIGS. 6 and 7, the outer container 70 includes a first opening 72. The first opening 72 is in communication with the total accommodating chamber 71. The cover portion 500 includes a lid 50 and a connector 40. The lid 50 includes threads. The connector 40 includes a first end of the connector (cover end) 401 and a second end of the connector 402. The first end of the connector 401 is in threaded connection with the lid 50. The second end of the connector 402 is in threaded connection with the first opening 72.

When the temperature-controlled cup stands on a table or on the ground, the first end of the connector 401 is the upper end of the connector 40, and the second end of the connector 402 is the lower end of the connector 40. When the user takes the medium holder 91 out of the total accommodating chamber 71, the connector 40 can be detached from the outer container 70. The connector 40 can restrict the medium holder 91 from separating from the total accommodating chamber 71. Then the medium holder 91 can be taken out through the first opening 72.

In some exemplary embodiments, with reference to FIGS. 6 and 7, the inner wall of the second end of the connector 402 is provided with internal threads, and the outer wall of the outer container 70 at the first opening 72 is provided with external threads corresponding to the above internal threads. By way of the internal and external threads, the inner wall of the second end of the connector 402 is threadedly connected to the outer wall of the outer container 70. This facilitates the passage of the medium holder 91 through the first opening 72 when the diameter of the first opening 72 is relatively small.

In some exemplary embodiments, the inner wall of the lid 50 is provided with internal threads, and the outer wall of the first end of the connector 401 is provided with external threads corresponding to the internal threads. By way of the internal and external threads, the inner wall of the lid 50 is threadedly connected to the outer wall of the first end of the connector 401. This facilitates the passage of the inner container 80 through the connector 40 when the diameter of the first end of the connector 401 (i.e., the first diameter D1 described below) is relatively small.

In some exemplary embodiments, please refer to FIGS. 6 and 7, where the first end of the connector 401 includes a second opening 403, and the second opening 403 has a first diameter D1. The second end of the connector 402 includes a third opening 404, and the third opening 404 has a second diameter D2. The first diameter D1 is smaller than the second diameter D2.

In some exemplary embodiments, the at least one medium holder 91 is cylindrical and has a third diameter D3. The third diameter D3 is smaller than the second diameter D2 and greater than the first diameter D1. The heat-insulation chamber 103 is columnar and has a fourth diameter D4, and the fourth diameter D4 is smaller than the first diameter D1. The third diameter D3 is the outer diameter of the end of the medium holder 91 close to the connector 40.

When the user takes the target object (for example, a feeding bottle) out of the heat-insulation chamber 103, the lid 50 can be detached from the connector 40, while the connector 40 remains connected to the outer container 70. The connector 40 can restrict the medium holder 91 from separating from the total accommodating chamber 71. Then the target object can be taken out through the second opening 403.

In some exemplary embodiments, with reference to FIGS. 6 and 7, the inner container 80 includes a bottle cap 22. The bottle cap 22 is located within the space formed by the connector 40. This improves the space utilization of the cup. The inner container 80 is not coupled to the connector 40. When the lid 50 is coupled to the connector 40, the lower surface of the lid 50 rests against the upper surface of the bottle cap 22. This allows the lid 50 to act as a positioning mechanism for the inner container 20.

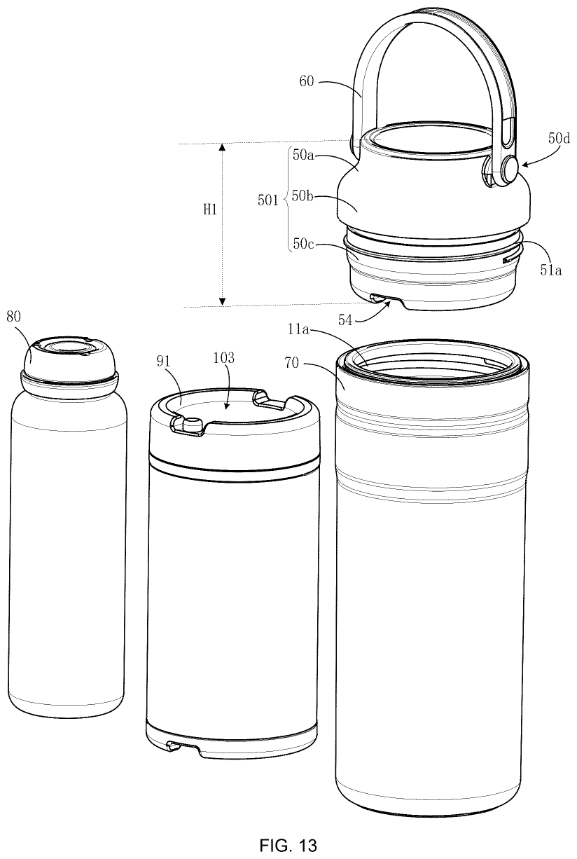

In some exemplary embodiments, the cover portion 500 may be configured as the structure of the cover portion 501 shown in FIG. 13 below. The specific details of the structure of the cover portion 501 are described below and will not be repeated herein.

In some exemplary embodiments, with reference to FIGS. 6 and 7, the temperature-controlled cup includes a handle 60. The handle 60 is connected to the cover portion 500. This facilitates the user to carry the temperature-controlled cup.

In some exemplary embodiments, the handle 60 is rotatably connected to the connector 40. This facilitates adjusting the position of the handle 60. The handle 60 may also serve the purpose of allowing a user to easily rotate the connector 40 by gripping the handle 60, facilitating the tightening or loosening of the threaded connection between the connector 40 and the outer container 10.

In some exemplary embodiments, with reference to FIGS. 6 to 10, the at least one medium holder 91 includes a body 32. The body 32 has a cylindrical structure, and the body 32 includes an inner wall 321 and an outer wall 322. The inner wall 321 forms the heat-insulation chamber 103, and a storage space 101 is formed between the inner wall 321 and the outer wall 322.

In some exemplary embodiments, the heat-insulation chamber 103 is columnar. The storage space 101 is annular. That is, the inner wall 321 is cylindrical, and the outer wall 322 is also cylindrical. Accordingly, the temperature-regulating medium is annular.

In some exemplary embodiments, the at least one medium holder 91 further includes a sealing member 31. At least one end of the body 32 has at least one notch 200.

In some exemplary embodiments, an injection port 300 is formed at the at least one notch 200, and the sealing member 31 is at least partially located within the injection port 300 to seal the injection port 300.

In the production process of the temperature-controlled cup, the injection port 300 is in communication with the storage space 101, and the temperature-regulating medium can enter the storage space 101 through the injection port 300.

In some exemplary embodiments, the sealing member 31 includes a head portion 311 and a rod portion 312 connected to each other. The rod portion 312 is located in the injection port 300 to block the injection port 300. The radial dimension of the head portion 311 is greater than the radial dimension of the injection port 300, forming an annular flange 313. The annular flange 313 is located within the notch 200 and abuts against the outer edge of the injection port 300.

In some exemplary embodiments, along the central axis of the cylindrical structure, the body 32 includes a first part 912 and a second part 913. The first part 912 is annular and has an annular first assembly opening 914. The second part 913 is cylindrical and has an annular second assembly opening 915. The first part 912 and the second part 913 are sealingly connected through the first assembly opening 914 and the second assembly opening 915.

In some exemplary embodiments, the at least one medium holder 91 includes a first medium holder 91 and a second medium holder 92. The first medium holder 91 is stacked on the second medium holder 92.

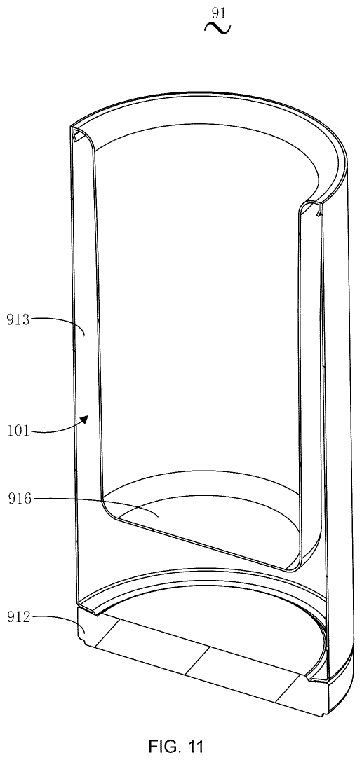

In some exemplary embodiments, please refer to FIG. 11, the at least one medium holder 91 includes a bottom wall 916. This is beneficial for increasing the contact area between the medium holder 91 and the target object, thereby improving heat transfer efficiency. For example, the body 32 includes a first part 912 and a second part 913. The first part 912 is circular and forms the outer layer of the bottom wall 916. The second part 913 is cylindrical and forms the inner layer of the bottom wall 916.

In some exemplary embodiments, please refer to FIGS. 6 and 7, the target object includes at least one inner container 80. The inner container 80 has a columnar structure. The diameter of the heat-insulation chamber 103 is greater than the diameter of the inner container 80. Furthermore, the diameter of the heat-insulation chamber 103 is slightly greater than the diameter of the inner container 80. For example, when the inner container 80 is placed into the heat-insulation chamber 103, the difference between the diameter of the heat-insulation chamber 103 and the inner container 80 at the corresponding position is less than 3 mm.

In some exemplary embodiments, the at least one inner container 80 includes a bottle cap 22 and a bottle body 21. The bottle body 21 is in threaded connection with the bottle cap 22. The threads on the bottle body 21 are configured to match and connect with the corresponding threads on the outlet of a breast pump.

In some exemplary embodiments, the bottom of the bottle body 21 is provided with a recessed structure 400 extending into the interior of the bottle body 21.

In some exemplary embodiments, the at least one inner container 80 comprises at least two inner containers 80, and the at least two inner containers 80 are stacked in the heat-insulation chamber 103. The sum of the height dimensions of the at least one medium holder 91 is adapted to the sum of the height dimensions of the at least one inner container 80.

Regarding the structure of inner container 80, reference may be made to the relevant description of the structure of inner container 20 mentioned previously; and will not be described again herein.

In some exemplary embodiments, the outer container 70 is generally cylindrical, and the outer wall 322 of the outer container 70 is provided with at least one stripe 701. For example, the stripe 701 can be arranged near the bottom of the outer container 70 or near the cover portion 500. Each stripe 701 can extend around the outer wall 322 of the outer container 70 for a full circle, half circle, or one-quarter circle.

In some exemplary embodiments, with reference to FIGS. 6 and 7, the temperature-controlled cup includes two inner containers 80 and two medium holders 91, 92. At this time, the inner container 80 needs to have a smaller capacity and a smaller height dimension, with the height dimension of each inner container 80 ranging from 100 mm to 145 mm. For example, the height dimension of each inner container 80 can be 110 mm, 120 mm, or 130 mm. Accordingly, the height dimension of each medium holder 91, 92 ranges from 100 mm to 145 mm. For example, the height dimension of each medium holder 91, 92 can be 110 mm, 120 mm, or 130 mm. The height dimension of each medium holder 91, 92 may be equal to, slightly larger than, or slightly smaller than the height dimension of each inner container 80.

The present disclosure provides a temperature-controlled cup. Please refer to FIGS. 6 and 7, the temperature-controlled cup includes an outer container 70, a cover portion 500, and at least one inner container 80. The cover portion 500 is in threaded connection with the outer container 70. The at least one inner container 80 is removably accommodated in the outer container 70. A storage space 101 is present between the at least one inner container 80 and the outer container 70 for placing a temperature-regulating medium.

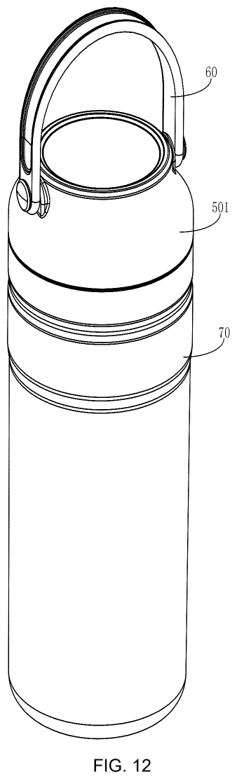

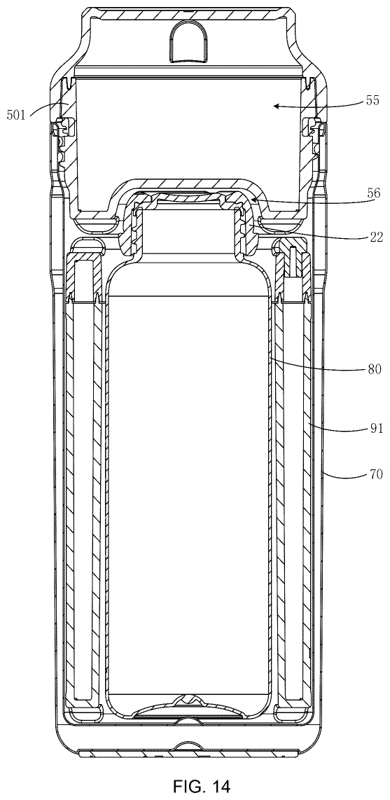

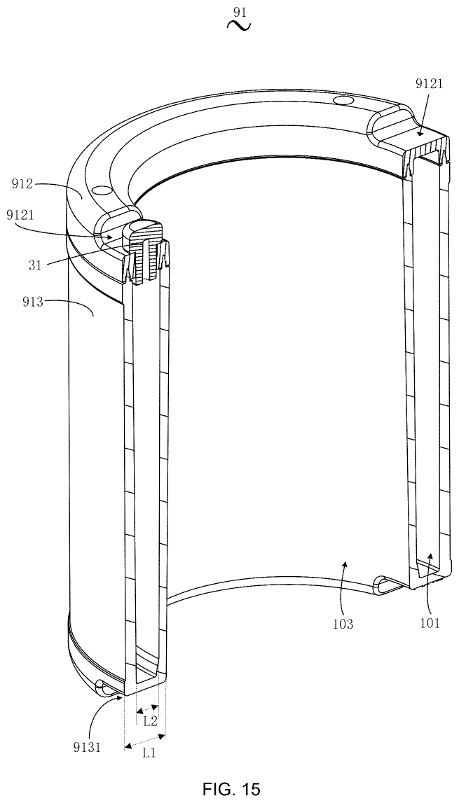

According to some exemplary embodiments of the present disclosure, FIGS. 12, 13, 14, and 15 provide another temperature-controlled cup. FIG. 12 is a schematic view of the structure of the temperature-controlled cup; FIG. 13 is a schematic view of the disassembled structure of the temperature-controlled cup; FIG. 14 is a schematic cross-sectional view of the temperature-controlled cup; FIG. 15 is a schematic view of the structure of the medium holder.

With reference to FIGS. 12, 13, 14, and 15, the temperature-controlled cup includes: an outer container 70, an inner container 80, a medium holder 91, and a temperature-regulating medium (not shown in the figures). The inner container 80 is removably accommodated in the outer container 70; the medium holder 91 is removably accommodated in the outer container 70 and is located between the outer container 70 and the inner container 80. The medium holder 91 is provided with a storage space 101; the temperature-regulating medium is accommodated in the storage space 101. Therefore, in the present disclosure, the accommodating space may also be referred to as the storage space.

In some exemplary embodiments, the medium holder 91 is cylindrical and surrounds the inner container 80 when the inner container 80 is accommodated in the outer container 70. That is, the medium holder 91 forms a heat-insulation chamber 103, and the inner container 80 is located within the heat-insulation chamber 103.

In some exemplary embodiments, with reference to FIGS. 13 and 14, the interior of the cover portion 501 can form a vacuum cavity 55 to provide thermal insulation. Furthermore, the cover portion 501 is formed through a welding process to produce the cavity 55. The lower end of the cover portion 501 includes at least one positioning groove 54, which is used to assist in positioning the lower end of the cover portion 501 during the welding process.

In some exemplary embodiments, with reference to FIGS. 13 and 14, the lower end of the cover portion 501 includes a positioning recess 56. The bottle cap 22 of the inner container 80 is located within the positioning recess 56. In this way, the cover portion 501 can simultaneously serve to position and insulate the inner container 80. This also improves the space utilization of the cup.

In some exemplary embodiments, with reference to FIGS. 13 and 14, the cover portion 501 may have a block-like shape. The height dimension H1 of the cover portion 501 ranges from 40 mm to 80 mm. For example, the height dimension H1 of the cover portion 501 can range from 40 mm to 50 mm, 50 mm to 60 mm, 60 mm to 70 mm, or 70 mm to 80 mm. A relatively large height dimension H1 of the cover portion 501 is beneficial for improving the thermal insulation effect.

In some exemplary embodiments, with reference to FIGS. 12, 13, and 14, a second coupling structure 11a is provided on the outer container 70. The temperature-controlled cup may further include a cover portion 501. The cover portion 501 is provided with a first coupling structure 51a. The second coupling structure 11a and the first coupling structure 51a correspond to each other. When the second coupling structure 11a and the first coupling structure 51a are coupled, the cover portion 501 is connected to the outer container 70.

In some exemplary embodiments, the second coupling structure 11a and the first coupling structure 51a are both threaded structures. For example, one of the second coupling structure 11a and the first coupling structure 51a is an internal thread, and the other is an external thread. In other embodiments, the second coupling structure 11a and the first coupling structure 51a may be fitted in other ways, such as by a snap fit, interference fit, etc. The embodiments of the present disclosure do not limit this.

In some exemplary embodiments, the first coupling structure 51a is disposed on the outer wall of the cover portion 501, and the second coupling structure 11a is disposed on the inner wall of the outer container 70. For example, the second coupling structure 11a may be an internal threaded structure provided on the inner wall of the outer container 70, and the first coupling structure 51a may be an external threaded structure provided on the outer wall of the cover portion 501.

In some exemplary embodiments, with reference to FIGS. 12, 13, and 14, the temperature-controlled cup may further include a handle 60, and the handle 60 is connected to the cover portion 501. Furthermore, the handle 60 is hinged to the cover portion 501. In this way, the handle 60 can rotate relative to the cover portion 501. When the handle 60 is laid flat, it can reduce the space occupied by the temperature-controlled cup, facilitating the user to store the temperature-controlled cup. The handle 60 may also serve the purpose of allowing a user to easily rotate the cover portion 501 by gripping the handle 60.

In some exemplary embodiments, with reference to FIGS. 12, 13, and 14, the cover portion 501 includes a first section 50a, a second section 50b, and a third section 50c connected in sequence. The first section 50a is connected to the handle 60, and the third section 50c is provided with the first coupling structure 51a. The radial dimension of the first section 50a is smaller than the radial dimension of the second section 50b, thereby forming a recessed structure space 50d on the outer periphery of the first section 50a. When the handle 60 is laid flat, at least a portion of the handle is located within the recessed structure space 50d.

The following describes the parameters of the inner container 80 and the medium holders (91, 92).

In some exemplary embodiments, to adapt to the amount of breast milk, the capacity of the inner container 80 as a feeding bottle is between 150 mL and 350 mL.

In some exemplary embodiments, to facilitate user handling, the outer diameter of the inner container 80 ranges from 40 mm to 70 mm. For example, the outer diameter of the inner container 80 ranges from 60 mm to 70 mm. In another example, the outer diameter of the inner container 80 ranges from 50 mm to 60 mm. The inner diameter of the medium holder 91 may be slightly larger than or equal to the outer diameter of the inner container 80.

In some exemplary embodiments, the inner diameter of the medium holders (91, 92) is between 65 mm and 70 mm. For example, the inner diameter of the media medium holders (91, 92) (i.e., the fourth diameter D4 mentioned above) is approximately 67.6 mm at room temperature. After freezing, the inner diameter of the media medium holders (91, 92) may shrink by about 1 mm. Of course, to facilitate demolding, the diameter dimensions of some of the parts mentioned above may vary slightly along the height of the cup.

In some exemplary embodiments, with reference to FIGS. 12, 13, and 14, the temperature-controlled cup includes one inner container 80 and one medium holder 91. At this time, the inner container 80 needs to have a larger capacity and a larger height dimension, with the height dimension ranging from 145 mm to 200 mm. For example, the height dimension of the inner container 80 may be 160 mm, 170 mm, or 180 mm. Accordingly, the height dimension of the medium holder 91 ranges from 145 mm to 200 mm. For example, the height dimension of the medium holder 91 may be 160 mm, 170 mm, or 180 mm. The height dimension of the medium holder 91 may be equal to, slightly larger than, or slightly smaller than the height dimension of the inner container 80.

In some exemplary embodiments, the storage space 101 is formed in the cylindrical wall of the medium holder 91. The radial width dimension L1 of the cylindrical wall of the medium holder 91 ranges from 8 mm to 14 mm. The radial width dimension L2 of the storage space 101 ranges from 4 mm to 10 mm.

In the above exemplary embodiments, the temperature-controlled cup preserves the temperature of a target object placed in the temperature-controlled cup through the medium holder (30, 91, 92). In the embodiments of the present disclosure, the target object is the inner container 20, 80. A person skilled in the art can understand that the target object may also be other objects (such as food, beverages, medical drugs, etc.).

In order to make the purpose, technical solution and advantages of the present disclosure more clearly understood, the present disclosure is further described in detail below in conjunction with the accompanying drawings and embodiments. It should be understood that the specific exemplary embodiments described herein are only used to explain the present disclosure and are not used to limit the present disclosure.

Certain features of embodiments of the claimed subject matter have been described herein; however, many modifications, substitutions, variations, and equivalents will now occur to a person skilled in the art. Furthermore, while several functional modules and the relationships between them have been described in detail, a person skilled in the art will recognize that several of the operations may be performed without the use of other functional modules, or that other functions or relationships between functions may be established and still conform to the claimed subject matter. It should be understood, therefore, that the appended claims are intended to cover all such modifications and variations that fall within the true spirit of embodiments of the claimed subject matter.

The above is only a specific implementation of the present disclosure. It should be pointed out that for ordinary technicians in this technical field, several improvements and modifications can be made without departing from the principles of the present disclosure. These improvements and modifications should also be regarded as the scope of protection of the present disclosure.

What is claimed is:

1. A temperature-controlled cup, comprising:
an outer container, comprising a total accommodating chamber;
a cover portion, in threaded connection with the outer container; and
at least one medium holder, removably accommodated in the total accommodating chamber, wherein
each of the at least one medium holder comprises:
a heat-insulation chamber for accommodating a target object, and
a storage space for accommodating a temperature-regulating medium.

2. The temperature-controlled cup according to claim 1, wherein
the outer container comprises a first opening; and
the cover portion comprises:
a lid, comprising threads, and
a connector, comprising a first end of the connector and a second end of the connector, wherein the first end of the connector is in threaded connection with the lid, and the second end of the connector is in threaded connection with the first opening.

3. The temperature-controlled cup according to claim 2, wherein the first cover end comprises a second opening, the second opening has a first diameter; the second cover end comprises a third opening, the third opening has a second diameter; and the first diameter is smaller than the second diameter.

4. The temperature-controlled cup according to claim 3, wherein the at least one medium holder is cylindrical and has a third diameter; the third diameter is smaller than the second diameter and greater than the first diameter; and
the heat-insulation chamber is columnar and has a fourth diameter, the fourth diameter is smaller than the first diameter.

5. The temperature-controlled cup according to claim 1, wherein an interior of the cover portion forms a vacuum cavity.

6. The temperature-controlled cup according to claim 1, further comprising: a handle, connected with the cover portion.

7. The temperature-controlled cup according to claim 1, wherein the at least one medium holder comprises:
a body, having a cylindrical structure and comprising an inner wall and an outer wall, wherein
the inner wall forms the heat-insulation chamber, and the storage space is formed between the inner wall and the outer wall.

8. The temperature-controlled cup according to claim 7, wherein the inner wall is cylindrical, and the outer wall is cylindrical.

9. The temperature-controlled cup according to claim 7, wherein the at least one medium holder further comprises a sealing member, and at least one end of the body comprises at least one notch.

10. The temperature-controlled cup according to claim 9, wherein an injection port is formed at the at least one notch, and the sealing member is at least partially located within the injection port to seal the injection port.

11. The temperature-controlled cup according to claim 10, wherein the sealing member comprises a head portion and a rod portion connected to the head portion;
the rod portion is located within the injection port to block the injection port;
a radial dimension of the head portion is greater than a radial dimension of the injection port, forming an annular flange; and
the annular flange is located within the notch and abuts against an outer edge of the injection port.

12. The temperature-controlled cup according to claim 8, wherein the body, along a central axis of the cylindrical structure, comprises:
a first part, annular and having an annular first assembly opening; and
a second part, cylindrical and having an annular second assembly opening, wherein
the first part and the second part are sealingly connected through the first assembly opening and the second assembly opening.

13. The temperature-controlled cup according to claim 1, wherein the at least one medium holder comprises a first medium holder and a second medium holder, and the first medium holder is stacked on the second medium holder.

14. The temperature-controlled cup according to claim 1, wherein the at least one medium holder comprises a bottom wall.

15. The temperature-controlled cup according to claim 1, wherein the target object comprises at least one inner container;
the inner container has a columnar structure; and
a diameter of the heat-insulation chamber is greater than a diameter of the inner container.

16. The temperature-controlled cup according to claim 15, wherein the at least one inner container comprises:
a bottle cap; and
a bottle body, connected with the bottle cap through a threaded connection, wherein
threads on the bottle body are configured to match and connect with corresponding threads on an outlet of a breast pump.

17. The temperature-controlled cup according to claim 16, wherein a bottom of the bottle body comprises a recessed structure extending into an interior of the bottle body.

18. The temperature-controlled cup according to claim 15, wherein the at least one inner container comprises at least two inner containers, the at least two inner containers are stacked in the heat-insulation chamber, and a sum of height dimensions of the at least one medium holder is adapted to a sum of height dimensions of the at least two inner containers.

19. The temperature-controlled cup according to claim 1, wherein the outer container is substantially cylindrical, and at least one stripe is formed on an outer wall of the outer container.

20. A temperature-controlled cup, comprising:
an outer container;
a cover portion, threadedly connected with the outer container; and
at least one inner container, removably accommodated in the outer container, wherein
a storage space is formed between the at least one inner container and the outer container to accommodate a temperature-regulating medium.
